(19) United States
(12) Patent Application Publication
(10) Pub. No.: US 2009/0027340 A1
(43) Pub. Date: Jan. 29, 2009

(54) FOLDABLE MOUSE

(75) Inventors: Hung-Chien Huang, Sijhih City (KR); Cheng-hua Chuang, Sijhih City (KR); Yen-Liang Kuan, Sijhih City (KR)

Correspondence Address: Muncy, Geissler, Olds & Lowe, PLLC, P.O. BOX 1364, FAIRFAX, VA, 22038-1364, US

(73) Assignee: BEHAVIOR TECH COMPUTER CORP.

(21) Appl. No.: 12/170,899

(22) Filed: Jul. 10, 2008

(30) Foreign Application Priority Data
Jul. 24, 2007 (KR) 96212113

(51) Int. Cl. G06F 3/033; G09G 5/08

(52) U.S. Cl. 345/163; 345/166

(57) ABSTRACT

A foldable mouse is disclosed. The foldable mouse includes a mouse body, a support portion, and a pivoting portion for connecting the support portion and the mouse body. The mouse body has a hollow surface and a sensing surface neighboring the hollow surface. The sensing surface is in contact with a reflection plane, and the hollow surface forms a cavity on the mouse body. The support portion can be contained in the cavity.

### RELATED APPLICATIONS

This application claims priority to Taiwan Application Serial Number 96212113, filed Jul. 24, 2007, which is herein incorporated by reference.

### BACKGROUND

1. Field of Invention

The present invention relates to a mouse. More particularly, the present invention relates to a foldable mouse.

2. Description of Related Art

The conventional peripheral interfaces for operating a computer includes a keyboard, a mouse, or a touch pad. A user can press, roll, slide, or touch the peripheral interface to input a signal, and the peripheral interface would transmit the signal into the processor of the computer to control the computer.

The shape and the size of the conventional mouse are fixed when the mouse is produced. The user cannot ensure that the mouse fits the hand before using the mouse. Thus, there is a need to provide a mouse that meets requirements from different users.

### SUMMARY

It is therefore an objective of the present invention to provide a foldable mouse to meet different palm shape of users.

The invention provides a foldable mouse. The foldable mouse includes a mouse body, a support portion, and a pivoting portion to connect the support portion and the mouse body. The mouse body has a hollow surface and a sensing surface neighboring the hollow surface. The sensing surface may touch a reflection plane, and the hollow surface forms a cavity on the mouse body. The support portion may be contained in the cavity.

The pivoting structure includes a first pivoting part disposed on the support portion and a second pivoting part disposed on the mouse body. The first pivoting part couples to the second pivoting part for connecting the support portion and the mouse body. The foldable mouse includes a light-sensing module disposed in the mouse body, wherein the sensing surface has an opening and two brackets disposed on two sides of the opening respectively. The light-sensing module is hung on the brackets, and the light-sensing module touches the reflection plane through the opening. The first pivoting part includes a slide rail; the mouse body includes a first linkage and a second linkage linked with the first linkage. An end of the first linkage is slid in the slide rail, and an end of the second linkage is linked with the light-sensing module to make the light-sensing module touches the reflection plane.

The light-sensing module may be disposed in the mouse body. A curved protrusion is disposed on the sensing surface and touches the reflection plane. The curved protrusion has a window. The light-sensing module is disposed above the window. An arch of the curved protrusion, which touches the reflection plane, is 2 mm to 4 mm. The foldable mouse further includes a battery and a receiver disposed in the support portion.

The size of the foldable mouse may be reduced when the foldable mouse is folded. The shape and the height of the foldable mouse may be adjusted for fitting different user's requirement with changing the angle between the support portion and the mouse body.

It is to be understood that both the foregoing general description and the following detailed description are by examples, and are intended to provide further explanations of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B illustrate schematic diagrams of different states of an embodiment of the foldable mouse of the invention;

FIG. 2A and FIG. 2B illustrate sectional diagrams of different states of another embodiment of the foldable mouse of the invention;

FIG. 2C illustrates an explosion diagram of the embodiment of the foldable mouse of the invention;

FIG. 3A and FIG. 3B illustrate cross-section diagrams of different states of another embodiment of the foldable mouse of the invention;

FIG. 3C illustrates an explosion diagram of the embodiment of the foldable mouse of the invention; and

FIG. 4 illustrates a top view schematic diagram of another embodiment of the foldable mouse of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

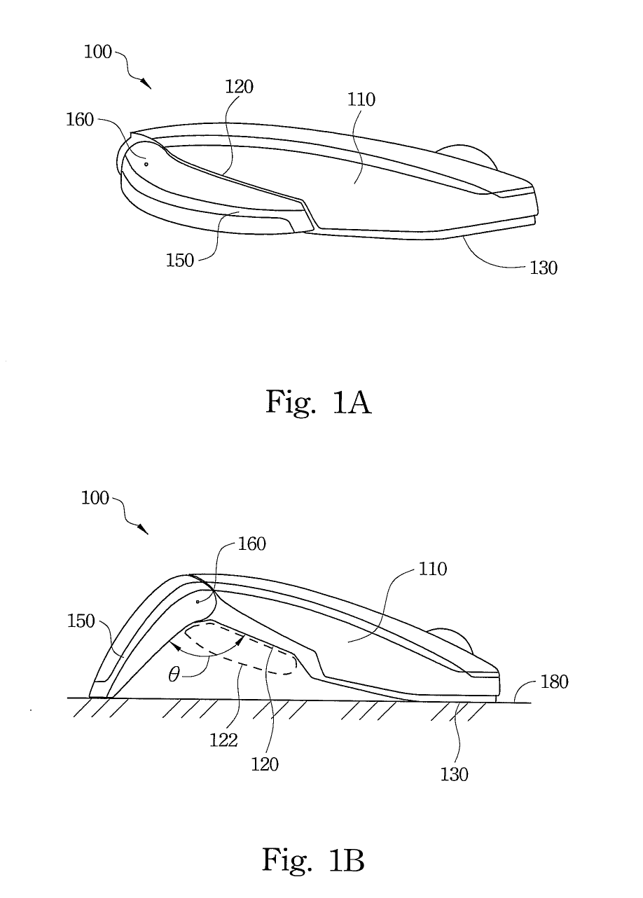

Refer to FIG. 1A and FIG. 1B. FIG. 1A and FIG. 1B illustrate schematic diagrams of different states of an embodiment of the foldable mouse of the invention. The foldable mouse 100 includes a mouse body 110, a support portion 150, and a pivoting structure 160 for connecting the mouse body 110 and the support portion 150. The mouse body 110 includes a roller, a printed circuit board, a light-sensing module, etc. The mouse body 110 has a hollow surface 120 and a sensing surface 130 neighboring the hollow surface 120. The sensing surface 130 is placed in contact with a reflection plane 180 when the foldable mouse 100 is used. The hollow surface 120 may form a cavity 122 on the mouse body 110. As shown in FIG. 1A, the support portion 150 of the foldable mouse 100 could be contained in the cavity 122 to reduce the size of the foldable mouse 100. The support portion 150 and the mouse body 110 may be unfolded when the user use the foldable mouse 100 as shown in FIG. 1B. The angle θ between the support portion 150 and the mouse body 110 can be changed, and the shape of the foldable mouse 100 could be altered by changing the angle θ to fit different user's palm shape.

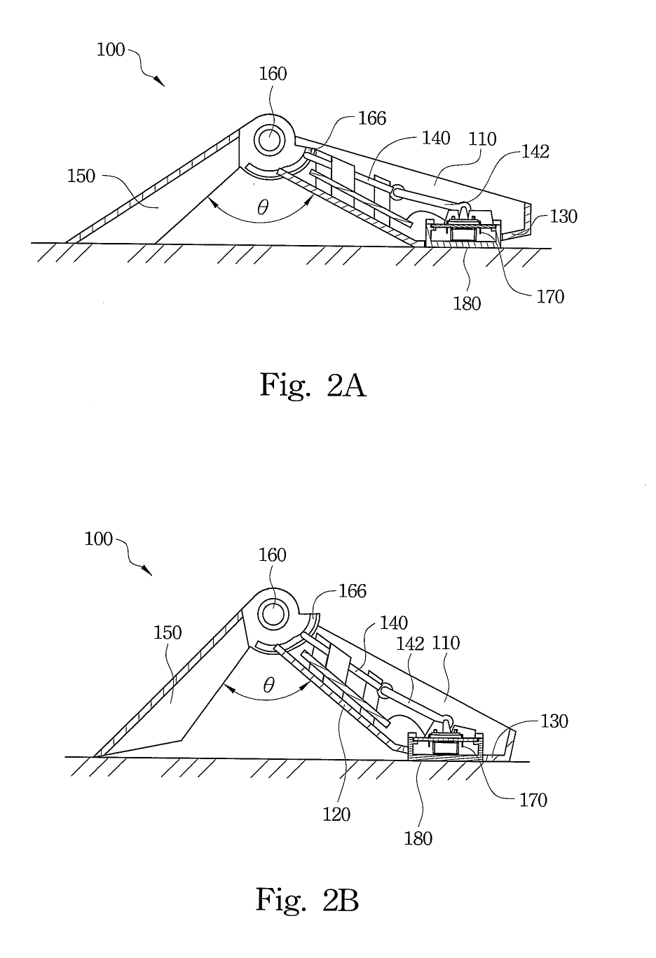

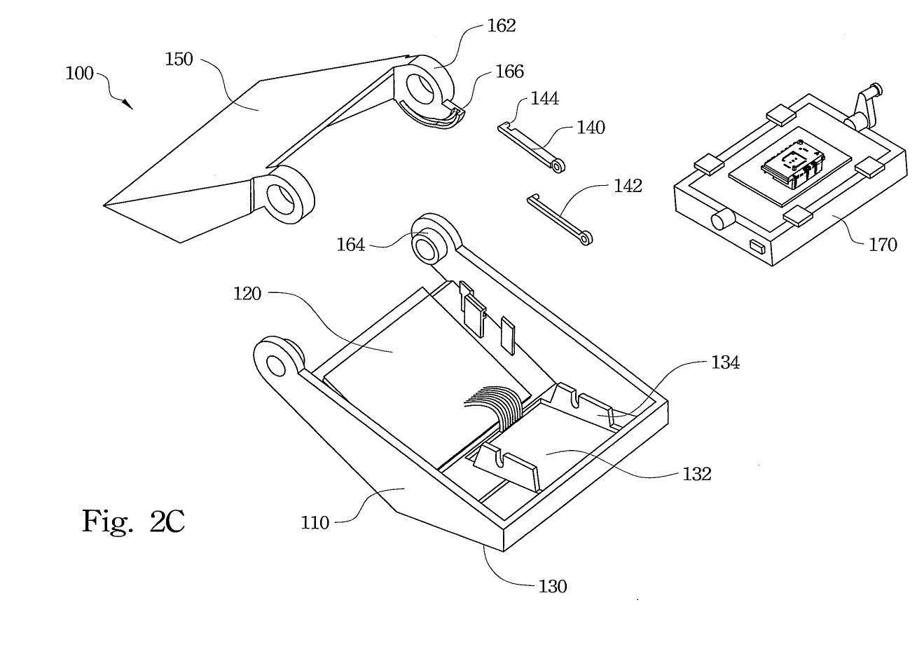

Refer to FIG. 2A to FIG. 2C. FIG. 2A and FIG. 2B illustrate sectional diagrams of different states of another embodiment of the foldable mouse of the invention. FIG. 2C illustrates an explosion diagram of the embodiment of the foldable mouse of the invention. The foldable mouse 100 in this embodiment omits the beautification of the case of the foldable mouse 100 for better description. As shown in FIG. 2C, the pivoting structure 160 includes a first pivoting part 162 disposed on the support portion 150 and a second pivoting part 164 disposed on the mouse body 110. The first pivoting part 162 couples with the second pivoting part 164 to connect the support portion 150 and the mouse body 110. The pivoting portion 160 further changes the angle θ between the support portion 150 and the mouse body 110.

Refer to FIG. 2A and FIG. 2B. The light-sensing module 170 is disposed in the mouse body 110. The sensing surface 130 of the foldable mouse 100 has an opening 132 and two brackets 134. The brackets 134 are disposed on two opposite sides of the opening 132 respectively. The light-sensing module 170 is hung on the brackets 134 and contacts the reflection plane 180 via the opening 132. The mouse body 110 includes a first linkage 140 and a second linkage 142. The first linkage 140 and the second linkage 142 can generate a securing force to ensure the light-sensing module 170 touching the reflection plane 180. The first pivoting part 162 has a slide rail 166. An end of the first linkage 140 has a sliding block 144. The sliding block 144 of the first linkage 140 slides in the sliding rail 166 of the first pivoting part 162. Another end of the first linkage 140 is pivoted with an end of the second linkage 142. Another end of the second linkage 142 is pivoted with the light-sensing module 170. As shown in FIG. 2A and FIG. 2B, the light-sensing module 170 is contact with the reflection plane 180 via the opening 132 by the securing force applied from the first linkage 140 and the second linkage 142.

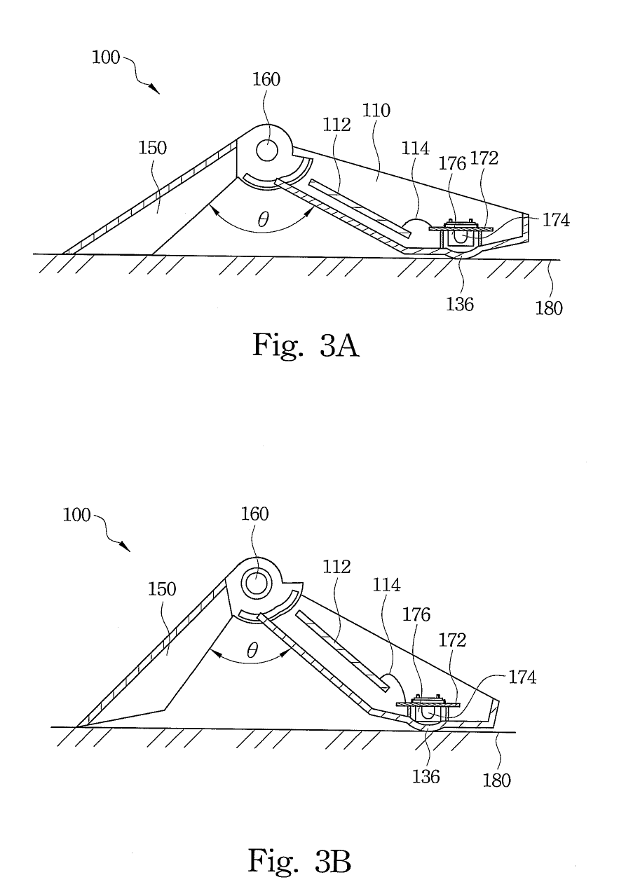

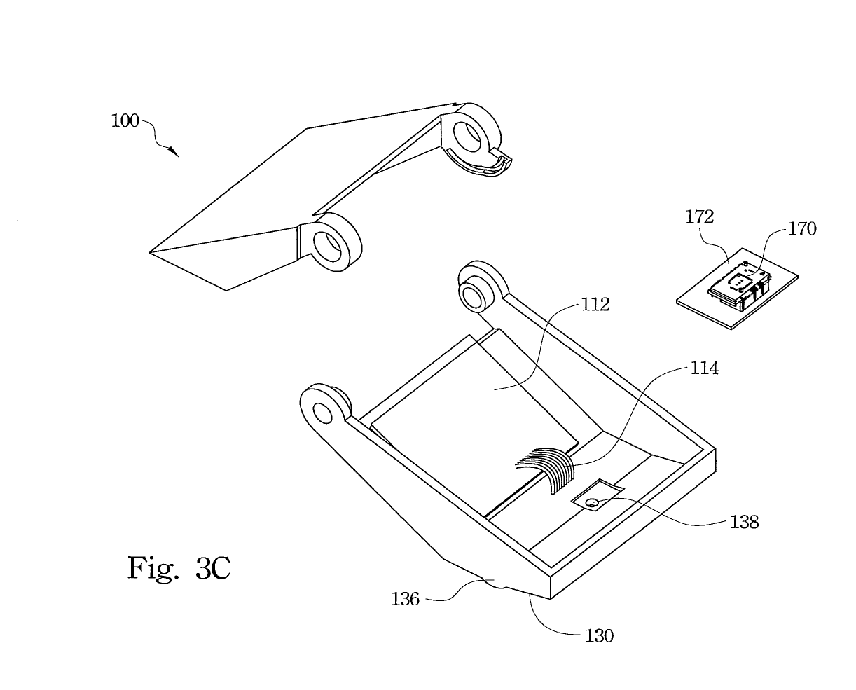

Refer to FIG. 3A to FIG. 3C. FIG. 3A and FIG. 3B illustrate cross-section diagrams of different states of another embodiment of the foldable mouse of the invention. FIG. 3C illustrates an explosion diagram of the embodiment of the foldable mouse of the invention. The light-sensing module 170 includes a first printed circuit board 172, a light-emitting component 174, and a light sensor 176. The mouse body 110 includes a second printed circuit board 112. The processor (not shown) of the foldable mouse 100 is placed on the second printed circuit board 112. The first printed circuit board 172 and the second printed circuit board 112 are connected with a bus line 114. The light-emitting component 174 may be an infrared light-emitting diode. The foldable mouse 100 further includes a curved protrusion 136 disposed on the sensing surface 130. The curved protrusion 136 is contact with the reflection surface 180. The curved protrusion 136 has a window 138, and the light-sensing module 170 is disposed over the window 138. As shown in FIG. 3A and FIG. 3B, the curved protrusion 136 of the sensing surface 130 can maintain the distance between the light-sensing module 170 and the reflection surface 180 within an allowable range when the user adjusts the angle θ between the mouse body 110 and the support portion 150. The arch touching the reflection surface 180 of the curved protrusion 136 is 2 mm to 4 mm.

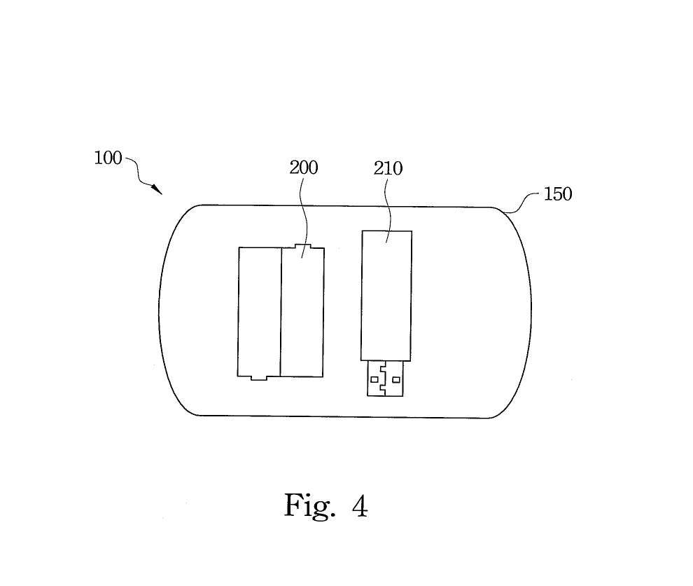

Refer to FIG. 4. FIG. 4 illustrates a top view schematic diagram of another embodiment of the foldable mouse of the invention. The foldable mouse 100 may be a wireless mouse. The battery 200 of the foldable mouse 100 may be disposed in the support portion 150. The foldable mouse 100 may further include a receiver 210. The receiver 210 may be contained in the support portion 150.

The size of the foldable mouse can be reduced when the foldable mouse is folded. The shape and the height of the foldable mouse can be adjusted for fitting different user's requirement with changing the angle between the support portion and the mouse body.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A foldable mouse comprising:
a mouse body comprising a hollow surface and a sensing surface neighboring the hollow surface, wherein the sensing surface contacts with a reflection plane, and the hollow surface forms a cavity on the mouse body;
a support portion; and
a pivoting structure for connecting the support portion and the mouse body, wherein the support portion is contained in the cavity.

2. The foldable mouse of claim 1, wherein the pivoting structure comprises a first pivoting part disposed on the support portion and a second pivoting part disposed on the mouse body; the first pivoting part couples to the second pivoting part for connecting the support portion and the mouse body.

3. The foldable mouse of claim 2, further comprising a light-sensing module disposed in the mouse body, wherein the sensing surface has an opening and two brackets disposed on two sides of the opening respectively; the light-sensing module is hung on the brackets, and the light-sensing module contacts the reflection plane via the opening.

4. The foldable mouse of claim 3, wherein the first pivoting part comprises a slide rail; the mouse body comprises a first linkage and a second linkage linked with the first linkage; an end of the first linkage is slid in the slide rail, and an end of the second linkage is linked with the light-sensing module, wherein the first linkage and the second linkage force the light-sensing module to touch the reflection plane.

5. The foldable mouse of claim 1, further comprising a light-sensing module disposed in the mouse body and a curved protrusion disposed on the sensing surface, which contacts with the reflection plane, wherein the curved protrusion has a window, the light-sensing module is disposed over the window.

6. The foldable mouse of claim 5, wherein an arch touching the reflection plane of the curved protrusion is 2 mm to 4 mm.

7. The foldable mouse of claim 1, further comprising a battery disposed in the support portion.

8. The foldable mouse of claim 1, further comprising a receiver disposed in the support portion.
